(19) United States
(12) Patent Application Publication
(10) Pub. No.: US 2026/0201701 A1
(43) Pub. Date: Jul. 16, 2026

(54) Protective Device For An Eave Gutter

(71) Applicant: Haikou Zhihui Weilai Trading Co., Ltd., Haikou (CN)

(72) Inventor: Mingyi Li, Haikou (CN)

(21) Appl. No.: 19/423,762

(22) Filed: Dec. 17, 2025

(30) Foreign Application Priority Data
Jan. 11, 2025 (CN) 2025200620563

(51) Int. Cl. E04D 13/076

(52) U.S. Cl. CPC E04D 13/076

(57) ABSTRACT

The present invention relates to a protective device for an eave gutter, including: a net having a plurality of holes, a first strip connector, a first groove, a first upper member, and a first lower member, the first upper member and the first lower member are both inclined upward at a certain angle relative to the plane or horizontal plane where the outer edge of the eave gutter is located, when the net is installed in the first groove, the first edge region of the net contacts the first upper member or the first lower member, thereby realizing that the net is inclined upward at a certain angle relative to the plane or horizontal plane where the outer edge of the eave gutter is located.

### CROSS-REFERENCE TO RELATED APPLICATIONS

This application is based on and claims priority from CN Application No. 2025200620563, filed on January 11, 2025, the disclosure of which is incorporated herein by reference in its entirety.

### Technical Field

The present invention relates to the technical field of gutter protective devices, specifically to a protective device for an eave gutter.

### Background of the Art

Eave gutters are used to receive rainwater from the roof, which is then directed to the ground by downpipes. For example, US20180112408A1 discloses a residential or commercial integrated perspective eave and downpipe gutter system, including at least one gutter section and one or more downpipe sections, and it may also include one or more elbow portions. Because the opening of the gutter is open, debris such as leaves, branches, pine needles, etc., easily falls into the gutter, leading to reduced water collection function of the gutter and even clogging of the gutter drain outlet.

US12378770B2 discloses a gutter protection system. Such solutions involve roughly horizontally installing a gutter protective cover or protective net on the gutter. Although this solves the problem of debris such as leaves, branches, pine needles, etc., easily falling into the gutter, when water flow is excessive, debris often accumulates on the protective cover or protective net. If such solutions involve directly bending the protective cover or protective net and installing it on the eave, so that the protective cover or protective net has roughly the same angle as the roof surface, the problem of debris easily accumulating on the protective cover can be solved, but it is easy to damage the protective cover or protective net, and the installation process is troublesome.

### SUMMARY OF THE PRESENT INVENTION

The present invention overcomes the limitations of the prior art. In some embodiments, a protective device for an eave gutter includes: a net having a plurality of holes and a first strip connector. The net has a first edge, a second edge, a third edge, and a fourth edge, the position of the first edge is arranged opposite to the position of the second edge, the position of the third edge is arranged opposite to the position of the fourth edge, the net is configured to at least partially cover the eave gutter, liquid can enter the eave gutter through the holes on the net, and the net can prevent debris from entering the eave gutter; the net also has a first edge region and a second edge region, the positions of the first edge region and the second edge region are arranged opposite to each other, the first edge region is the part close to the first edge of the net, and the second edge region is the part close to the second edge of the net. The first strip connector is installed on the outer edge of the eave gutter, the first strip connector has a first groove, the first edge region of the net is installed in the first groove. Wherein, the first groove upper part is provided with a first upper member, the first groove lower part is provided with a first lower member, the first upper member and the first lower member are both inclined upward at a certain angle relative to the plane or horizontal plane where the outer edge of the eave gutter is located. When the net is installed in the first groove, the first lower member supports the first edge region of the net, so that this area contacts the first upper member or the first lower member, thereby realizing that the net is inclined upward at a certain angle relative to the plane or horizontal plane where the outer edge of the eave gutter is located.

The present invention overcomes the limitations of the prior art. In some embodiments, a protective device for an eave gutter includes: a net having a plurality of holes and a first strip connector. The net has a first edge, a second edge, a third edge, and a fourth edge, the position of the first edge is arranged opposite to the position of the second edge, the position of the third edge is arranged opposite to the position of the fourth edge, the net is configured to at least partially cover the eave gutter, liquid can enter the eave gutter through the holes on the net, and the net can prevent debris from entering the eave gutter; the net also has a first edge region and a second edge region, the positions of the first edge region and the second edge region are arranged opposite to each other, the first edge region is the part close to the first edge of the net, and the second edge region is the part close to the second edge of the net. The first strip connector is installed on the outer edge of the eave gutter, the first strip connector has a first groove, the first edge region of the net is installed in the first groove. Wherein, the first groove upper part is provided with a first upper member, the first groove lower part is provided with a first lower member, the first strip connector further has a first piece, the first upper member and the first lower member are respectively connected to the first piece, the first upper member and the first lower member are both inclined upward at a certain angle relative to the first piece. When the net is installed in the first groove, the first lower member supports the first edge region of the net, so that this area contacts the first upper member or the first lower member, thereby realizing that the net is inclined upward at a certain angle relative to the first piece.

The present invention overcomes the limitations of the prior art. In some embodiments, a protective device for an eave gutter includes: a net having a plurality of holes, a first strip connector, and a second strip connector. The net has a first edge, a second edge, a third edge, and a fourth edge, the position of the first edge is arranged opposite to the position of the second edge, the position of the third edge is arranged opposite to the position of the fourth edge, the net is configured to at least partially cover the eave gutter, liquid can enter the eave gutter through the holes on the net, and the net can prevent debris from entering the eave gutter; the net also has a first edge region and a second edge region, the positions of the first edge region and the second edge region are arranged opposite to each other, the first edge region is the part close to the first edge of the net, and the second edge region is the part close to the second edge of the net. The first strip connector is installed on the outer edge of the eave gutter, the first strip connector has a first groove, the first edge region of the net is installed in the first groove. The second strip connector is installed below the eave fascia, the second edge region of the net is installed on the second strip connector. Wherein, the first groove upper part is provided with a first upper member, the first groove lower part is provided with a first lower member, the first upper member and the first lower member are both inclined upward at a certain angle relative to the plane or horizontal plane where the outer edge of the eave gutter is located. When the net is installed in the first groove, the first lower member supports the first edge region of the net, so that this area contacts the first upper member or the first lower member, thereby realizing that the net is inclined upward at a certain angle relative to the plane or horizontal plane where the outer edge of the eave gutter is located.

### BRIEF DESCRIPTION OF THE DRAWINGS

In order to more clearly illustrate the specific embodiments of the present invention or the technical solutions in the prior art, the following will briefly describe the drawings needed in the specific embodiments or the description of the prior art. Obviously, the drawings in the following description are some embodiments of the present invention, and for those of ordinary skill in the art, other drawings can be obtained based on these drawings without creative effort.

FIG. 1 is a schematic structural view of an exemplary protective device for an eave drain.

FIG. 2 is a sectional view of an exemplary use state.

FIG. 3 is an enlarged view of part a in FIG. 2.

FIG. 4 is a cross-sectional view of an exemplary protective device for an eaves gutter.

FIG. 5 is an explosion structure diagram of FIG. 4.

FIG. 6 is a schematic structural view of an exemplary first strip connector.

FIG. 7 is a schematic structural view of an exemplary second strip connector.

FIG. 8 is a schematic structural view of another exemplary first strip connector.

FIG. 9 is a schematic structural view of another exemplary second strip connector.

FIG. 10 is a sectional view of another exemplary use state.

FIG. 11 is another exemplary use state diagram.

FIG. 12 is an enlarged view of part b in FIG. 1.

FIG. 13 is an enlarged view of part A' in FIG. 2.

In the drawings: net 1, first edge 11, second edge 12, third edge 13, fourth edge 14, first strip connector 2, first groove 21, 21', first piece 22, 22', second piece 23, 23', second strip connector 3, second groove 31, 31', third piece 32, 32', fourth piece 33, 33', first limiting member 41, second limiting member 42, eave gutter 5, outer edge 51, inner edge 52, eave fascia 6, corrugations 7, first upper member 211, 211', first lower member 212, 212', third groove 221, fourth groove 321, horizontal plane P, included angle α, α', included angle β, β', fifth piece 213, 213', second upper member 311, 311', second lower member 312, 312', sixth piece 313, 313'.

### DETAILED DESCRIPTION

To make the objectives, technical solutions, and advantages of the embodiments of the present invention clearer, the following will clearly and completely describe the technical solutions in the embodiments of the present invention with reference to the accompanying drawings. Obviously, the described embodiments are only a part of the embodiments of the present invention, not all of them. The components of the embodiments of the present invention described and shown in the drawings herein can be arranged and designed in various different configurations. Therefore, the following detailed description of the embodiments of the present invention provided in the drawings is not intended to limit the scope of the claimed invention, but merely represents selected embodiments of the present invention. Based on the embodiments of the present invention, all other embodiments obtained by those of ordinary skill in the art without creative effort shall fall within the protection scope of the present invention.

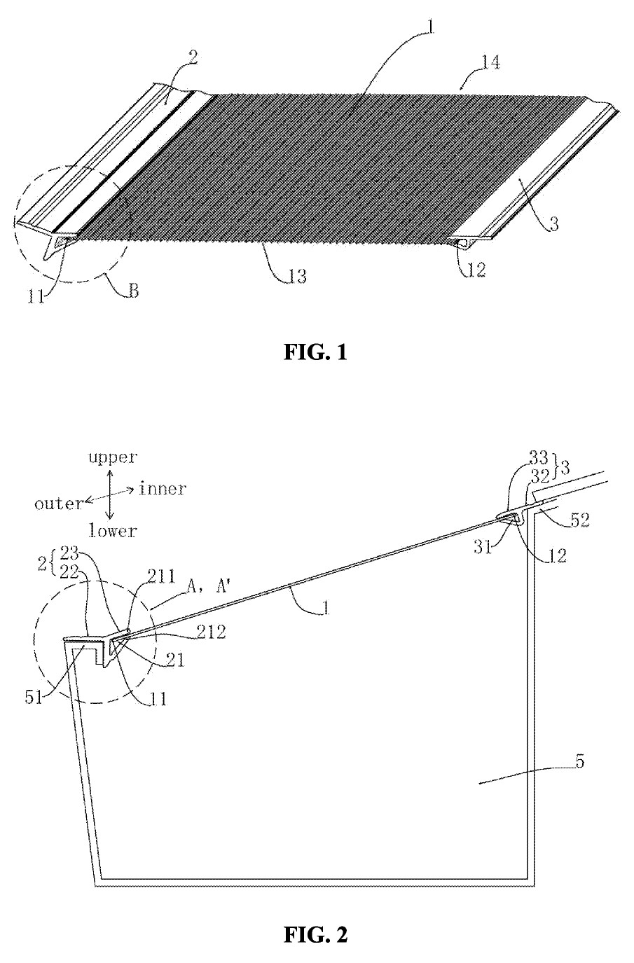

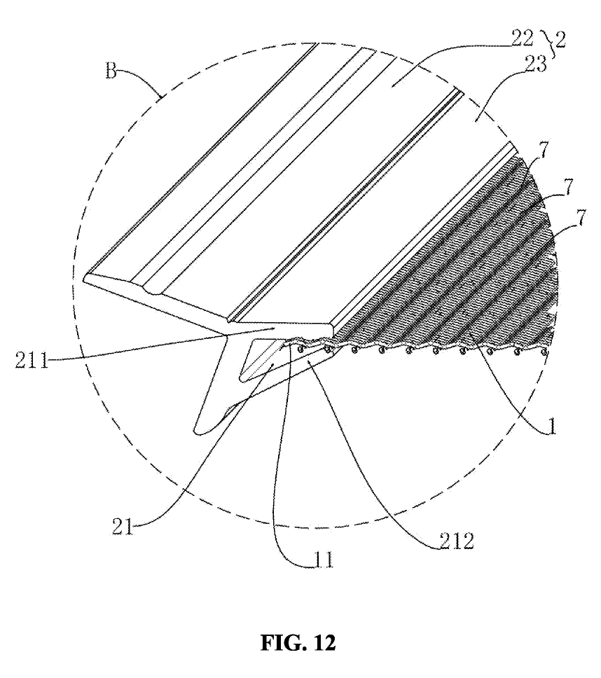

As shown in FIGS. 1-5 and FIG. 12, an embodiment of the present invention relates to a protective device for an eave gutter, including: a net 1 having a plurality of holes and a first strip connector 2. The net 1 has a first edge 11, a second edge 12, a third edge 13, and a fourth edge 14, the position of the first edge 11 is arranged opposite to the position of the second edge 12, the position of the third edge 13 is arranged opposite to the position of the fourth edge 14, the overall shape of the net 1 is rectangular, the net 1 is configured to at least partially cover the eave gutter 5, liquid can enter the eave gutter 5 through the holes on the net 1, and the net 1 can prevent debris from entering the eave gutter 5. The net 1 also has a first edge region and a second edge region, the positions of the first edge region and the second edge region are arranged opposite to each other, the first edge region is the part close to the first edge 11 of the net 1, and the second edge region is the part close to the second edge 12 of the net 1. The first strip connector 2 is installed on the outer edge 51 of the eave gutter 5, the first strip connector 2 has a first groove 21, the first edge region of the net 1 is installed in the first groove 21. Wherein, the first groove 21 upper part is provided with a first upper member 211, the first groove 21 lower part is provided with a first lower member 212, the first upper member 211 and the first lower member 212 are both inclined upward at a certain angle relative to the plane or horizontal plane P where the outer edge 51 of the eave gutter 5 is located; the first upper member 211 forms an included angle α relative to the plane or horizontal plane P where the outer edge 51 of the eave gutter 5 is located, the first lower member 212 forms an included angle β relative to the plane or horizontal plane P where the outer edge 51 of the eave gutter 5 is located.

When the net 1 is installed in the first groove 21, the first lower member 212 supports the first edge region of the net 1, so that this area contacts the first upper member 211, thereby realizing that the net 1 is inclined upward at a certain angle relative to the plane or horizontal plane P where the outer edge 51 of the eave gutter 5 is located; so that the net 1 has a natural upward angle, thereby realizing that the side of the device close to the eave is inserted into the eave at roughly the same angle as the roof surface, or the side of the device close to the eaves is installed on the inner edge 52 of the eave gutter 5 at approximately the same angle as the roof, solving the problems that existing eave gutter protective devices easily accumulate debris on the protective device, and when installing the protective device, the protective device is easily bent and installation is troublesome.

In some embodiments, when the net 1 is installed in the first groove 21, the first lower member 212 supports the first edge region of the net 1, so that this area contacts the first lower member 212, thereby realizing that the net 1 is inclined upward at a certain angle relative to the plane or horizontal plane P where the outer edge 51 of the eave gutter 5 is located; so that the net 1 has a natural upward angle, thereby realizing that the side of the device close to the eave is inserted into the eave at roughly the same angle as the roof surface, or the side of the device close to the eaves is installed on the inner edge 52 of the eave gutter 5 at approximately the same angle as the roof, solving the problems that existing eave gutter protective devices easily accumulate debris on the protective device, and when installing the protective device, the protective device is easily bent and installation is troublesome.

The plane where the outer edge 51 is located in the present invention refers to the upper surface or the lower surface of the outer edge 51.

In the present invention, the horizontal plane P where the outer edge 51 is located refers to the horizontal plane penetrating the center position of the outer edge 51, or the horizontal plane parallel to the horizontal plane penetrating the center position of the outer edge 51.

The eave gutter 5 in the present invention is a conventional product in the field, and is only briefly described here. The eave gutter 5 is connected to the eave fascia 6, for example, a fascia board, whose function is to collect rainwater from the eave fascia 6 and discharge the collected rainwater from the eave gutter 5 to the ground or into a sewage pipe.

In the present invention, “eave fascia” refers to glass fiber asphalt shingles, slates, slates, tiles or wood chips laid on the surface of the roof.

The eave gutter 5 in the present invention has an outer edge 51 and an inner edge 52, the position of the outer edge 51 and the position of the inner edge 52 are arranged opposite to each other, the outer edge 51 of the eave gutter 5 refers to the gutter edge away from the eave direction, and the inner edge 52 of the eave gutter 5 refers to the gutter edge close to the eave direction.

As shown in FIG. 3, in some embodiments, the first upper member 211 is inclined upward at an angle greater than 0 degrees and less than 90 degrees relative to the plane or horizontal plane where the outer edge 51 of the eave gutter 5 is located; the first lower member 212 is inclined upward at an angle greater than 0 degrees and less than 90 degrees relative to the plane or horizontal plane where the outer edge 51 of the eave gutter 5 is located. That is, the angles of included angle α and included angle β are both greater than 0 degrees and less than 90 degrees.

The angles of included angle α and included angle β can be the same or different. The user selects a suitable inclination angle according to the roof angle, thereby achieving that when the first groove 21 of the first strip connector 2 clamps the net 1, it has a natural upward angle, so that one side of the device close to the eaves is inserted into the eaves or installed on the inner edge 52 of the eave gutter 5 at the same angle as the roof. For example, the angle of included angle α is 1 degree, 10 degrees, 13 degrees, 15 degrees, 18 degrees, 20 degrees, or 60 degrees; for example, the angle of included angle β is 40 degrees, 50 degrees, or 60 degrees.

As shown in FIGS. 1-5, in some embodiments, the protective device for an eave gutter further includes a second strip connector 3, the second strip connector 3 is installed on the inner edge 52 of the eave gutter 5, the second edge region of the net 1 is installed on the second strip connector 3.

As shown in FIG. 11, in some embodiments, the second strip connector 3 is installed below the eave fascia 6, and a portion of the eave fascia 6 covers a part of the net 1.

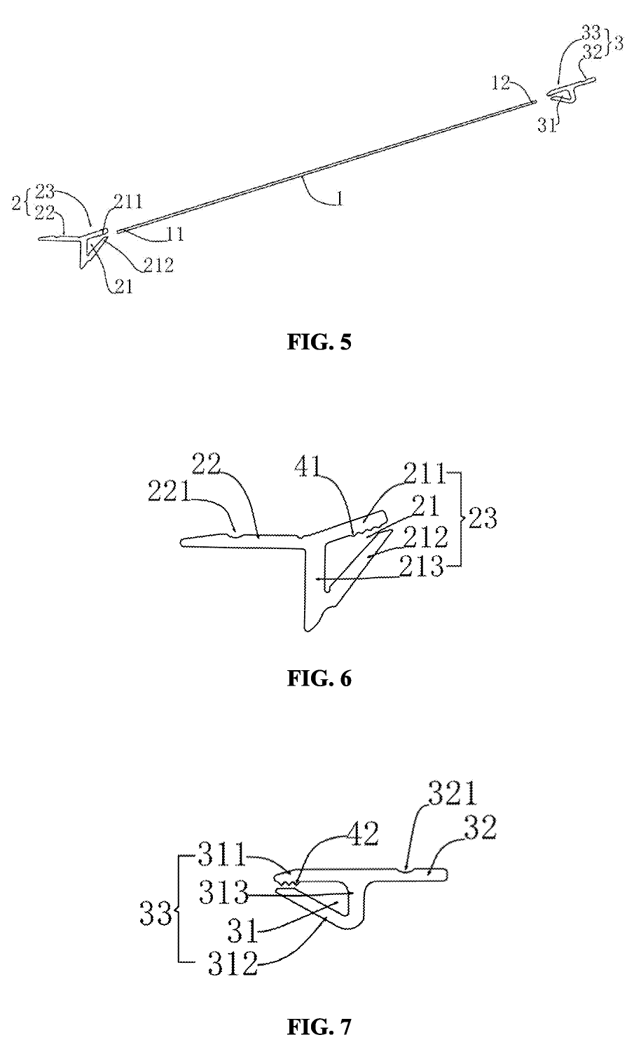

As shown in FIGS. 4-5, the second strip connector 3 has a second groove 31, the second edge region of the net 1 is installed in the second groove 31.

As shown in FIG. 6, in some embodiments, the first strip connector 2 has a first piece 22 and a second piece 23, the first piece 22 and the second piece 23 are connected. The first piece 22 is installed on the outer edge 51 of the eave gutter 5. The second piece 23 is provided with the first groove 21 for installing the first edge region of the net 1.

As shown in FIG. 7, in some embodiments, the second strip connector 3 has a third piece 32 and a fourth piece 33, the third piece 32 and the fourth piece 33 are connected; the third piece 32 is installed on the inner edge 52 of the eave gutter 5, the inner edge 52 of the eave gutter 5 is located below the eave. The fourth piece 33 is provided with the second groove 31 for installing the second edge region of the net 1.

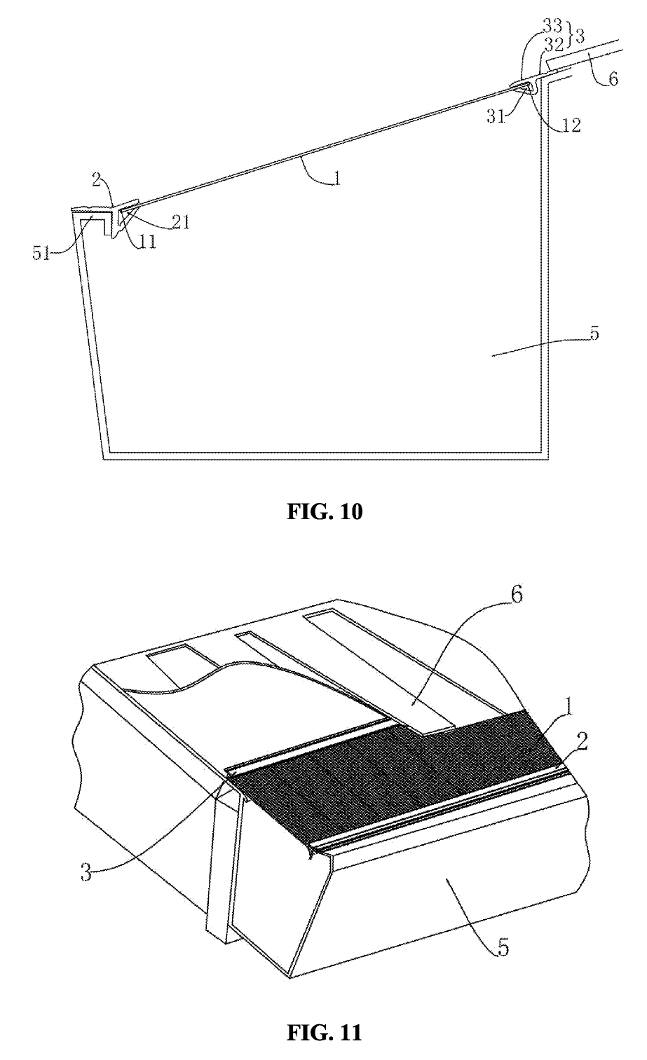

As shown in FIG. 10, in some embodiments, the third piece 32 is installed below the eave fascia 6.

As shown in FIG. 6, in some embodiments, the first strip connector 2 further has a fifth piece 213, one side of the upper part of the fifth piece 213 is connected to the first upper member 211, the other side of the upper part of the fifth piece 213 is connected to the first piece 22, the lower part of the fifth piece 213 is connected to the first lower member 212; wherein, there is a certain distance between the first upper member 211 and the first lower member 212, the first upper member 211 and the first lower member 212 form the first groove 21 between them, the first upper member 211, the first lower member 212, the fifth piece 213, and the first groove 21 together form the second piece 23 for installing the net 1. The first edge region at the lower end of the net 1 is installed in the first groove 21 of the second piece 23.

As shown in FIG. 7, in some embodiments, the second strip connector 3 further has a second upper member 311, a second lower member 312, and a sixth piece 313. One side of the upper part of the sixth piece 313 is connected to the second upper member 311, the other side of the upper part of the sixth piece 313 is connected to the third piece 32, the lower part of the sixth piece 313 is connected to the second lower member 312. Wherein, there is a certain distance between the second upper member 311 and the second lower member 312, the second upper member 311 and the second lower member 312 form the second groove 31 between them, the second upper member 311, the second lower member 312, the sixth piece 313, and the second groove 31 together form the fourth piece 33 for installing the net 1. The second edge region at the upper end of the net 1 is installed in the second groove 31 of the fourth piece 33.

As shown in FIG. 6, in some embodiments, the upper surface of the first piece 22 is provided with a third groove 221, the third groove 221 is used to guide rainwater on the first piece 22 to flow into the eave gutter 5 or to the left and right sides of the eave through the third groove 221.

In some embodiments, it further includes a first connecting member not shown, the first connecting member is snap-fitted into the third groove 221, when multiple first pieces 22 are placed on the eave gutter 5, by snap-fitting the first connecting member into each third groove 221 respectively, the multiple first pieces 22 are fixedly connected together.

In some embodiments, the upper surface of the third piece 32 is provided with a fourth groove 321, the fourth groove 321 is connected with a buckle of the eave fascia 6, the bottom edge of the eave fascia 6 or a protrusion on the bottom surface of the eave fascia 6 is snap-fitted into the fourth groove 321.

In some embodiments, it further includes a second connecting member not shown, the second connecting member is snap-fitted into the fourth groove 321, when multiple third pieces 32 are placed on the eave gutter 5 or below the eave fascia 6, by snap-fitting the second connecting member into each fourth groove 321 respectively, the multiple third pieces 32 are fixedly connected together.

In some embodiments, the thickness of the outer edge of the first piece 22 gradually thins from the inside to the outside.

In some embodiments, the holes on the net 1 are one of circular, rectangular, square, and elliptical.

In some embodiments, the shape of the second piece 23 is at least one of U-shaped, V-shaped, rectangular, triangular, trapezoidal, and arc-shaped. As shown in FIG. 6, in at least one embodiment, the overall shape of the second piece 23 is triangular, and one corner of the triangle has a fine opening, and the net 1 installs the first edge region into the first groove 21 through this opening. Since the overall shape of the second piece 23 is triangular, and one of the corners of the triangle has a small opening, the second piece 23 forms a component with a clamping function. When the first edge region of the net 1 is installed in the first groove 21, the second piece 23 can clamp the first edge region, so that the first edge region of the net 1 is stably installed in the first groove 21.

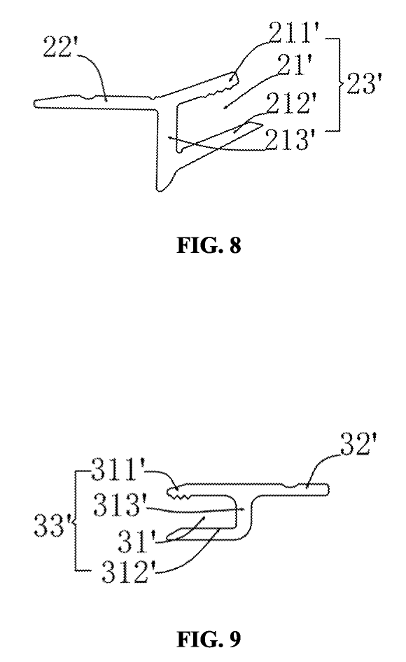

As shown in FIG. 8, in some embodiments, the first strip connector 2 further has a fifth piece 213', a first upper member 211', a first lower member 212', and a first piece 22'. One side of the upper part of the fifth piece 213' is connected to the first upper member 211', the other side of the upper part of the fifth piece 213' is connected to the first piece 22', the lower part of the fifth piece 213' is connected to the first lower member 212'. Wherein, there is a certain distance between the first upper member 211' and the first lower member 212', the first upper member 211' and the first lower member 212' form the first groove 21' between them, the first upper member 211', the first lower member 212', the fifth piece 213', and the first groove 21' together form the second piece 23' for installing the net 1.

As shown in FIG. 8, in at least one embodiment, the shape of the second piece 23' is an inclined U-shape, and the end of the U-shape has an opening, and the net 1 installs the first edge region into the first groove 21' through this opening.

In some embodiments, the shape of the fourth piece 33 is at least one of U-shaped, V-shaped, rectangular, triangular, trapezoidal, and arc-shaped. As shown in FIG. 7, in at least one embodiment, the overall shape of the fourth piece 33 is triangular, and one corner of the triangle has a fine opening, and the net 1 installs the second edge region into the second groove 31 through this opening. Similarly, since the fourth piece 33 is triangular in shape and has a small opening at one corner, it also functions as a clamp. When the second edge region of the net 1 is installed in the second groove 31, the fourth piece 33 can clamp the second edge region, ensuring its stable installation within the groove.

As shown in FIG. 9, in some embodiments, the second strip connector 3 further has a second upper member 311', a second lower member 312', a sixth piece 313', and a third piece 32'. One side of the upper part of the sixth piece 313' is connected to the second upper member 311', the other side of the upper part of the sixth piece 313' is connected to the third piece 32', the lower part of the sixth piece 313' is connected to the second lower member 312'. Wherein, there is a certain distance between the second upper member 311' and the second lower member 312', the second upper member 311' and the second lower member 312' form the second groove 31' between them, the second upper member 311', the second lower member 312', the sixth piece 313', and the second groove 31' together form the fourth piece 33' for installing the net 1.

As shown in FIG. 9, in at least one embodiment, the shape of the fourth piece 33' is a horizontally placed U-shape, and the end of the U-shape has an opening, and the net 1 installs the second edge region into the second groove 31' through this opening.

As shown in FIG. 1, the first strip connector 2 and the second strip connector 3 are both elongated strip members, and the first groove 21 and the second groove 31 are elongated grooves.

In some embodiments, the overall shape of the first piece 22 and the third piece 32 are rectangular plates.

In some embodiments, the net 1 is made of at least one of stainless steel, iron, copper, aluminum, and plastic.

In some embodiments, the corrugations 7 in the net 1 are formed by at least one of stamping, pressing, and weaving.

In some embodiments, the first groove 21 is provided with a first limiting member 41, and the second groove 31 is provided with a second limiting member 42.

As shown in FIG. 6, in at least one embodiment, the lower surface of the first upper member 211 is provided with a first limiting member 41, the first limiting member 41 is a serrated protrusion, and the serrated protrusion can increase the friction between the lower surface of the first upper member 211 and the net 1, preventing the net 1 from moving freely in the first groove 21.

As shown in FIG. 7, in at least one embodiment, the lower surface of the second upper member 311 is provided with a second limiting member 42, the second limiting member 42 is a serrated protrusion, and the serrated protrusion can increase the friction between the lower surface of the second upper member 311 and the net 1, preventing the net 1 from moving freely in the second groove 31.

As shown in FIGS. 1, 2, 4, 5, and 13, in some embodiments, a protective device for an eave gutter includes: a net 1 having a plurality of holes and a first strip connector 2. The net 1 has a first edge 11, a second edge 12, a third edge 13, and a fourth edge 14, the position of the first edge 11 is arranged opposite to the position of the second edge 12, the position of the third edge 13 is arranged opposite to the position of the fourth edge 14, the overall shape of the net 1 is rectangular, the net 1 is configured to at least partially cover the eave gutter 5, liquid can enter the eave gutter 5 through the holes on the net 1, and the net 1 can prevent debris from entering the eave gutter 5. The net 1 also has a first edge region and a second edge region, the positions of the first edge region and the second edge region are arranged opposite to each other, the first edge region is the part close to the first edge 11 of the net 1, and the second edge region is the part close to the second edge 12 of the net 1. The first strip connector 2 is installed on the outer edge 51 of the eave gutter 5, the first strip connector 2 has a first groove 21, the first edge region of the net 1 is installed in the first groove 21. Wherein, the first groove 21 upper part is provided with a first upper member 211, the first groove 21 lower part is provided with a first lower member 212, the first strip connector 2 further has a first piece 22, the first upper member 211 and the first lower member 212 are respectively connected to the first piece 22, the first upper member 211 and the first lower member 212 are both inclined upward at a certain angle relative to the first piece 22. The first upper member 211 forms an included angle α' relative to the transverse center line P' of the first piece 22, the first lower member 212 forms an included angle β' relative to the transverse center line P' of the first piece 22.

In the present invention, the transverse center line P' of the first piece 22 refers to a horizontal line passing through the center point of the first piece 22.

When the net 1 is installed in the first groove 21, the first lower member 212 of the first groove 21 supports the first edge region of the net 1, so that this area contacts the first upper member 211, thereby realizing that the net 1 is inclined upward at a certain angle relative to the first piece 22; so that the net 1 has a natural upward angle, thereby realizing that the side of the device close to the eave is inserted into the eave at roughly the same angle as the roof surface, or the side of the device close to the eaves is installed on the inner edge 52 of the eave gutter 5 at approximately the same angle as the roof, solving the problems that existing eave gutter protective devices easily accumulate debris on the protective device, and when installing the protective device, the protective device is easily bent and installation is troublesome.

In some embodiments, when the net 1 is installed in the first groove 21, the first lower member 212 of the first groove 21 supports the first edge region of the net 1, so that this area contacts the first lower member 212, thereby realizing that the net 1 is inclined upward at a certain angle relative to the first piece 22; so that the net 1 has a natural upward angle, thereby realizing that the side of the device close to the eave is inserted into the eave at roughly the same angle as the roof surface, or the side of the device close to the eaves is installed on the inner edge 52 of the eave gutter 5 at approximately the same angle as the roof, solving the problems that existing eave gutter protective devices easily accumulate debris on the protective device, and when installing the protective device, the protective device is easily bent and installation is troublesome.

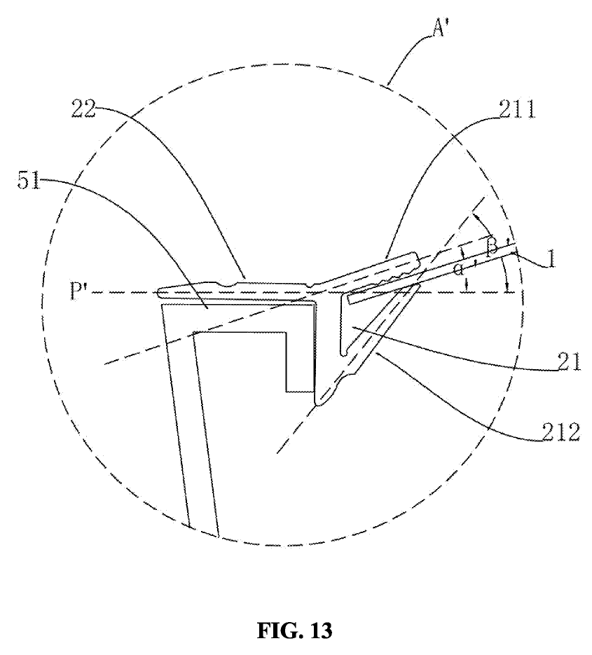

As shown in FIG. 13, in some embodiments, the first upper member 211 is inclined upward at an angle greater than 0 degrees and less than 90 degrees relative to the first piece 22; the first lower member 212 is inclined upward at an angle greater than 0 degrees and less than 90 degrees relative to the first piece 22. That is, the angles of included angle α' and included angle β' are both greater than 0 degrees and less than 90 degrees.

The angles of included angle α' and included angle β' can be the same or different. The user selects a suitable inclination angle according to the roof angle, thereby achieving that when the first groove 21 of the first strip connector 2 clamps the net 1, it has a natural upward angle, so that one side of the device close to the eaves is inserted into the eaves or installed on the inner edge 52 of the eave gutter 5 at the same angle as the roof. For example, the angle of included angle α' is 1 degree, 10 degrees, 13 degrees, 15 degrees, 18 degrees, 20 degrees, or 60 degrees; for example, the angle of included angle β' is 40 degrees, 50 degrees, or 60 degrees.

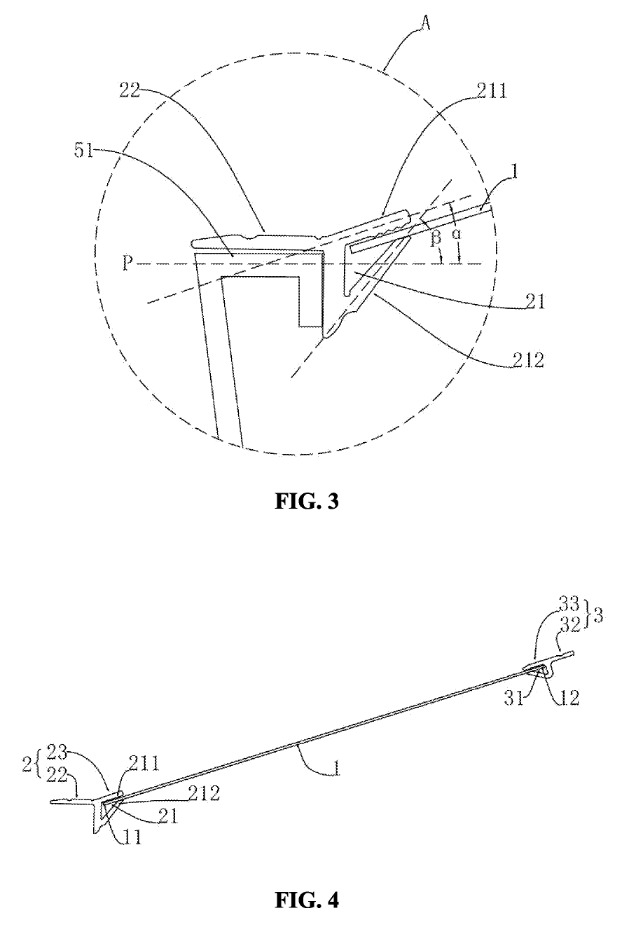

Among them, FIG. 13 and FIG. 3 are both enlarged views of the part where the first strip connector 2 is installed on the outer edge 51 of the eave gutter 5 in FIG. 2. The difference between the two FIGS. is that the reference objects for the inclination angles of the first upper member 211 and the first lower member 212 are different.

As shown in FIGS. 4-5, in some embodiments, the first strip connector 2 further has a second piece 23, the second piece 23 and the first piece 22 are connected. The first piece 22 is installed on the outer edge 51 of the eave gutter 5; the second piece 23 is provided with the first groove 21 for installing the first edge region of the net 1.

As shown in FIGS. 10 and 11, in some embodiments, a protective device for an eave gutter includes: a net 1 having a plurality of holes, a first strip connector 2, and a second strip connector 3. The net 1 has a first edge 11, a second edge 12, a third edge 13, and a fourth edge 14, the position of the first edge 11 is arranged opposite to the position of the second edge 12, the position of the third edge 13 is arranged opposite to the position of the fourth edge 14, the overall shape of the net 1 is rectangular, the net 1 is configured to at least partially cover the eave gutter 5, liquid can enter the eave gutter 5 through the holes on the net 1, and the net 1 can prevent debris from entering the eave gutter 5. The net 1 also has a first edge region and a second edge region, the positions of the first edge region and the second edge region are arranged opposite to each other, the first edge region is the part close to the first edge 11 of the net 1, and the second edge region is the part close to the second edge 12 of the net 1. The first strip connector 2 is installed on the outer edge 51 of the eave gutter 5, the first strip connector 2 has a first groove 21, the first edge region of the net 1 is installed in the first groove 21. The second strip connector 3 is installed below the eave fascia 6, the second edge region of the net 1 is installed on the second strip connector 3; wherein, the net 1 is provided with a plurality of corrugations in the horizontal direction or vertical direction or diagonal direction, the first groove 21 upper part is provided with a first upper member 211, the first groove 21 lower part is provided with a first lower member 212, the first upper member 211 and the first lower member 212 are both inclined upward at a certain angle relative to the plane or horizontal plane where the outer edge 51 of the eave gutter 5 is located.

When the net 1 is installed in the first groove 21, the first lower member 212 of the first groove 21 supports the first edge region of the net 1, so that this area contacts the first upper member 211, thereby realizing that the net 1 is inclined upward at a certain angle relative to the plane or horizontal plane where the outer edge 51 of the eave gutter 5 is located, so that the net 1 has a natural upward angle, thereby realizing that the side of the device close to the eave is inserted into the eave at roughly the same angle as the roof surface, solving the problems that existing eave gutter protective devices easily accumulate debris on the protective device, and when installing the protective device, the protective device is easily bent and installation is troublesome.

In some embodiments, when the net 1 is installed in the first groove 21, the first lower member 212 of the first groove 21 supports the first edge region of the net 1, so that this area contacts the first lower member 212, thereby realizing that the net 1 is inclined upward at a certain angle relative to the plane or horizontal plane where the outer edge 51 of the eave gutter 5 is located, so that the net 1 has a natural upward angle, thereby realizing that the side of the device close to the eave is inserted into the eave at roughly the same angle as the roof surface, solving the problems that existing eave gutter protective devices easily accumulate debris on the protective device, and when installing the protective device, the protective device is easily bent and installation is troublesome.

In the present invention, the technical solutions involve the orientations/directions of “upper, lower, inner, outer” which are based on the content shown in FIG. 2 as the reference basis.

Furthermore, the terms “upper”, “lower”, “front”, “rear”, “left”, “right” in the above are only used for descriptive purposes and cannot be understood as indicating or implying relative importance. Unless otherwise specifically stated, the relative steps, numerical expressions, and numerical values of the components and steps described in these embodiments do not limit the scope of the present invention.

Furthermore, the terms “first”, “second”, etc. in the above are only used to distinguish the described objects and do not have any order or technical meaning, and cannot be understood as indicating or implying relative importance or implicitly indicating the number of the indicated technical features.

In the description of the present invention, unless otherwise specified, “a plurality” means two or more, unless explicitly defined otherwise.

Of course, the above are only specific embodiments of the present invention and are not intended to limit the implementation scope of the present invention. Any equivalent changes or modifications made to the structure, features, and principles according to the patent scope of the present invention should be included within the patent scope of the present invention.

The above embodiments are only specific embodiments of the present invention, used to illustrate the technical solutions of the present invention, and not to limit them. The protection scope of the present invention is not limited thereto. Although the present invention has been described in detail with reference to the foregoing embodiments, those of ordinary skill in the art should understand that: any person skilled in the art can make modifications or easily conceivable changes to the technical solutions described in the foregoing embodiments within the technical scope disclosed in the present invention, or make equivalent replacements to some of the technical features; and these modifications, changes, or replacements do not make the essence of the corresponding technical solutions deviate from the spirit and scope of the technical solutions of the embodiments of the present invention, and should be included within the protection scope of the present invention. Therefore, the protection scope of the present invention should be based on the protection scope of the claims.

What is claimed is:

1. A protective device for an eave gutter, characterized by comprising:
a net having a plurality of holes, said net having a first edge, a second edge, a third edge, and a fourth edge, the position of the first edge is arranged opposite to the position of the second edge, the position of the third edge is arranged opposite to the position of the fourth edge, said net is configured to at least partially cover the eave gutter, liquid can enter the eave gutter through the holes on the net, and the net can prevent debris from entering the eave gutter;
the net also has a first edge region and a second edge region, the positions of the first edge region and the second edge region are arranged opposite to each other, the first edge region is the part close to the first edge of the net, and the second edge region is the part close to the second edge of the net;
a first strip connector, said first strip connector is installed on the outer edge of the eave gutter, the first strip connector has a first groove, said first edge region of the net is installed in the first groove;
wherein, said first groove upper part is provided with a first upper member, said first groove lower part is provided with a first lower member, the first upper member and the first lower member are both inclined upward at a certain angle relative to the plane or horizontal plane where the outer edge of the eave gutter is located;
when the net is installed in the first groove, the first lower member supports the first edge region of the net, so that this area contacts the first upper member or the first lower member, thereby realizing that the net is inclined upward at a certain angle relative to the plane or horizontal plane where the outer edge of the eave gutter is located.

2. The protective device for an eave gutter according to claim 1, characterized in that, said first upper member is inclined upward at an angle greater than 0 degrees and less than 90 degrees relative to the plane or horizontal plane where the outer edge of the eave gutter is located;
the first lower member is inclined upward at an angle greater than 0 degrees and less than 90 degrees relative to the plane or horizontal plane where the outer edge of the eave gutter is located.

3. The protective device for an eave gutter according to claim 1, characterized by further comprising a second strip connector, said second strip connector is installed on the inner edge of the eave gutter, said second edge region of the net is installed on the second strip connector;
said second strip connector has a second groove, said second edge region of the net is installed in the second groove.

4. The protective device for an eave gutter according to claim 1, characterized in that, said first strip connector has a first piece and a second piece, the first piece and the second piece are connected;
the first piece is installed on the outer edge of the eave gutter;
the second piece is provided with the first groove for installing the first edge region of the net.

5. The protective device for an eave gutter according to claim 3, characterized in that, said second strip connector has a third piece and a fourth piece, the third piece and the fourth piece are connected;
the third piece is installed on the inner edge of the eave gutter;
the fourth piece is provided with the second groove for installing the second edge region of the net.

6. The protective device for an eave gutter according to claim 4, characterized in that, said first strip connector further has a fifth piece, one side of the upper part of said fifth piece is connected to the first upper member, the other side of the upper part of the fifth piece is connected to the first piece, the lower part of the fifth piece is connected to the first lower member;
wherein, there is a certain distance between the first upper member and the first lower member, the first upper member and the first lower member form the first groove between them, the first upper member, the first lower member, the fifth piece, and the first groove together form the second piece.

7. The protective device for an eave gutter according to claim 5, characterized in that, said second strip connector further has a second upper member, a second lower member, and a sixth piece;
one side of the upper part of the sixth piece is connected to the second upper member, the other side of the upper part of the sixth piece is connected to the third piece, the lower part of the sixth piece is connected to the second lower member;
wherein, there is a certain distance between the second upper member and the second lower member, the second upper member and the second lower member form the second groove between them, the second upper member, the second lower member, the sixth piece, and the second groove together form the fourth piece.

8. The protective device for an eave gutter according to claim 1, characterized in that, said net is made of at least one of stainless steel, iron, copper, aluminum, and plastic.

9. The protective device for an eave gutter according to claim 7, characterized in that, the lower surface of the first upper member is provided with a first limiting member, the first limiting member can increase the friction between the lower surface of the first upper member and the net;
the lower surface of the second upper member is provided with a second limiting member, the second limiting member can increase the friction between the lower surface of the second upper member and the net.

10. A protective device for an eave gutter, characterized by comprising:
a net having a plurality of holes, said net having a first edge, a second edge, a third edge, and a fourth edge, the position of the first edge is arranged opposite to the position of the second edge, the position of the third edge is arranged opposite to the position of the fourth edge, said net is configured to at least partially cover the eave gutter, liquid can enter the eave gutter through the holes on the net, and the net can prevent debris from entering the eave gutter;
the net also has a first edge region and a second edge region, the positions of the first edge region and the second edge region are arranged opposite to each other, the first edge region is the part close to the first edge of the net, and the second edge region is the part close to the second edge of the net;
a first strip connector, said first strip connector is installed on the outer edge of the eave gutter, the first strip connector has a first groove, said first edge region of the net is installed in the first groove;
wherein, said first groove upper part is provided with a first upper member, said first groove lower part is provided with a first lower member, the first strip connector further has a first piece, the first upper member and the first lower member are respectively connected to the first piece, the first upper member and the first lower member are both inclined upward at a certain angle relative to the first piece;
when the net is installed in the first groove, the first lower member supports the first edge region of the net, so that this area contacts the first upper member or the first lower member, thereby realizing that the net is inclined upward at a certain angle relative to the first piece.

11. The protective device for an eave gutter according to claim 10, characterized in that, said first upper member is inclined upward at an angle greater than 0 degrees and less than 90 degrees relative to the first piece;
the first lower member is inclined upward at an angle greater than 0 degrees and less than 90 degrees relative to the first piece.

12. The protective device for an eave gutter according to claim 10, characterized by further comprising a second strip connector, said second strip connector is installed on the inner edge of the eave gutter, said second edge region of the net is installed on the second strip connector;
said second strip connector has a second groove, said second edge region of the net is installed in the second groove.

13. The protective device for an eave gutter according to claim 10, characterized in that, said first strip connector further has a second piece, the second piece and the first piece are connected;
the first piece is installed on the outer edge of the eave gutter;
the second piece is provided with the first groove for installing the first edge region of the net.

14. The protective device for an eave gutter according to claim 12, characterized in that, said second strip connector has a third piece and a fourth piece, the third piece and the fourth piece are connected;
the third piece is installed on the inner edge of the eave gutter;
the fourth piece is provided with the second groove for installing the second edge region of the net.

15. The protective device for an eave gutter according to claim 14, characterized in that, the upper surface of the first piece is provided with a third groove, the upper surface of the third piece is provided with a fourth groove;
the thickness of the outer edge of the first piece gradually thins from the inside to the outside.

16. A protective device for an eave gutter, characterized by comprising:
a net having a plurality of holes, said net having a first edge, a second edge, a third edge, and a fourth edge, the position of the first edge is arranged opposite to the position of the second edge, the position of the third edge is arranged opposite to the position of the fourth edge, said net is configured to at least partially cover the eave gutter, liquid can enter the eave gutter through the holes on the net, and the net can prevent debris from entering the eave gutter;
the net also has a first edge region and a second edge region, the positions of the first edge region and the second edge region are arranged opposite to each other, the first edge region is the part close to the first edge of the net, and the second edge region is the part close to the second edge of the net;
a first strip connector, said first strip connector is installed on the outer edge of the eave gutter, the first strip connector has a first groove, said first edge region of the net is installed in the first groove;
a second strip connector, said second strip connector is installed below the eave fascia, said second edge region of the net is installed on the second strip connector;
wherein, said first groove upper part is provided with a first upper member, said first groove lower part is provided with a first lower member, the first upper member and the first lower member are both inclined upward at a certain angle relative to the plane or horizontal plane where the outer edge of the eave gutter is located;
when the net is installed in the first groove, the first lower member supports the first edge region of the net, so that this area contacts the first upper member or the first lower member, thereby realizing that the net is inclined upward at a certain angle relative to the plane or horizontal plane where the outer edge of the eave gutter is located.

17. The protective device for an eave gutter according to claim 16, characterized in that, said first upper member is inclined upward at an angle greater than 0 degrees and less than 90 degrees relative to the plane or horizontal plane where the outer edge of the eave gutter is located;
the first lower member is inclined upward at an angle greater than 0 degrees and less than 90 degrees relative to the plane or horizontal plane where the outer edge of the eave gutter is located.

18. The protective device for an eave gutter according to claim 16, characterized in that, said second strip connector has a second groove, said second edge region of the net is installed in the second groove.

19. The protective device for an eave gutter according to claim 16, characterized in that, said first strip connector has a first piece and a second piece, the first piece and the second piece are connected;
the first piece is installed on the outer edge of the eave gutter;
the second piece is provided with the first groove for installing the first edge region of the net.

20. The protective device for an eave gutter according to claim 16, characterized in that, said second strip connector has a third piece and a fourth piece, the third piece and the fourth piece are connected;
the third piece is installed below the eave fascia;
the fourth piece is provided with the second groove for installing the second edge region of the net.
